(19) United States
(12) Patent Application Publication
(10) Pub. No.: US 2012/0271555 A1
(43) Pub. Date: Oct. 25, 2012

(54) DEVICE FOR MEASURING TISSUE STIFFNESS

(76) Inventors: Ilya Levental, Philadelphia, PA (US); Paul Janmey, Media, PA (US); Paavo Kinnunen, Espoo (FI)

(21) Appl. No.: 13/387,302

(22) PCT Filed: Jul. 27, 2010
(86) PCT No.: PCT/US10/43399

§ 371 Date: Jul. 9, 2012

Related U.S. Application Data
(60) Provisional application No. 61/228,783, filed on Jul. 27, 2009.

(51) Int. Cl. G06F 19/00; G01L 1/00

(52) U.S. Cl. 702/19; 73/862.381

(57) ABSTRACT

This invention relates to measuring stiffness of a biological sample Specifically, the invention relates to a milliprobe indentation device that comprises a force probe and a micromanipulator and uses thereof for measuring stiffness of biological samples

### CROSS REFERENCE TO RELATED APPLICATIONS

This application claims priority to U.S. Provisional Patent Application 61/228,783, filed Jul. 27, 2009, which is incorporated by reference herein in its entirety.

### FIELD OF THE INVENTION

The invention relates to a device for measuring tissue stiffness. Specifically, the invention relates to a device for measuring tissue stiffness with sub-millimeter resolution.

### BACKGROUND OF THE INVENTION

Recent research has highlighted the relevance of physical environmental factors as vital regulators of cell and tissue function. Specifically, the stiffness of cellular substrates has been implicated in controlling a variety of cell behaviors, including but not limited to proliferation, migration (in the context of invasion and metastasis), synapse development, growth rate, cytokinesis, development of fibrosis, and stem cell differentiation. Additionally, whole tissue stiffness has been shown to be a risk factor for the development of cancer as well as an important diagnostic read-out in pathologic processes involving tissue injury and fibrosis, including cancer and liver disease. These findings, which have demonstrated unequivocally the relevance of mechanical stimuli in biological function, have established the need for accurate and high resolution characterization of the elasticity of biological tissues.

Current methods exist for the characterization of material properties of biological samples. Some of these are classical methods developed for material evaluation that have been adapted to suit the softness typical of most biological samples. These modules typically measure material bulk properties by tension, compression, rheometry, or macroindentation. While these techniques have been used extensively to characterize biological tissues, they have limited size resolution, and typically measure the material properties of whole tissues, neglecting the variation inherent in structurally complex biological samples.

At the other extreme of size resolution are techniques that evaluate nano- and microscopic material properties. These include atomic force microscopy and microaspiration, both of which have been used to probe sub-cellular mechanical properties. These techniques are generally more complex and require significant investment of time and resources to acquire results. More importantly, since these techniques sample mechanical properties at sub-micrometer length-scales, they are not appropriate for determining these properties at a scale relevant to whole tissue function.

Although several methods are currently available for measuring stiffness, these typically measure mechanical properties either at a global scale (i.e. whole tissue tensile, compression or rheometry analysis) or at a cellular level (e.g. atomic force microscopy (AFM) or micropipette aspiration). To date, the intermediate (i.e. 100 micron to millimeter) scale of tissue stiffness, where variation would be expected in both normal and diseased tissue, has not been explored because of a lack of experimental tools available for such an application.

Accordingly, there exits a need for an improved device and methods for measuring tissue stiffness.

### SUMMARY OF THE INVENTION

In one embodiment, the invention provides a device for measuring stiffness of a soft material with sub-millimeter resolution, the device comprising: (a) a force probe having a tensiometric cantilever disposed therein, wherein the distal end of said cantilever comprises a cylindrical wire for interfacing with said soft material; and (b) a micromanipulator for displacing said soft material.

In another embodiment, the invention provides a milliprobe indentation device for measuring stiffness of a biological sample, the device comprising: (a) a force probe comprising a tensiometric cantilever disposed therein, wherein the distal end of said cantilever comprises a cylindrical wire with variable tip geometries for interfacing with said biological sample; and (b) a micromanipulator for displacing said biological sample.

In another embodiment, the invention provides a milliprobe indentation system for measuring stiffness of a biological sample, the device comprising: (a) a force probe comprising a tensiometric cantilever disposed therein, wherein the distal end of said cantilever comprises a cylindrical wire for interfacing with said biological sample; and (b) a micromanipulator for displacing said biological sample.

In another embodiment, the invention provides a method for measuring stiffness of a biological sample, the method comprising: providing a milliprobe indentation device for measuring stiffness of a biological sample, the device comprising: (a) a force probe comprising a tensiometric cantilever disposed therein, wherein the distal end of said cantilever comprises a cylindrical wire for interfacing with said biological sample; and (b) a micromanipulator for displacing said biological sample; and measuring stiffness of said biological sample.

In another embodiment, the invention provides a method for measuring stiffness of a removed tissue or biopsy sample of a subject, the method comprising: providing a milliprobe indentation device for measuring stiffness of a biological sample, the device comprising: (a) a force probe comprising a tensiometric cantilever disposed therein, wherein the distal end of said cantilever comprises a cylindrical wire for interfacing with said biological sample; and (b) a micromanipulator for displacing said biological sample; and measuring stiffness of said biological sample.

In another embodiment, the invention provides a method for measuring stiffness of a biological sample with sub-millimeter size scale, the method comprising: collecting said biological sample from a subject; providing a milliprobe indentation device that comprises: (a) a force probe comprising a tensiometric cantilever disposed therein, wherein the distal end of said cantilever comprises a cylindrical wire for interfacing with said biological sample; and (b) a micromanipulator for displacing said biological sample; measuring force on said cantilever; measuring vertical displacement of said sample; and collecting and analyzing data.

In another embodiment, the invention provides a method for measuring stiffness of a removed tissue or biopsy sample with sub-millimeter size scale, the method comprising: collecting said biological sample from a subject; providing a milliprobe indentation device that comprises: (a) a force probe comprising a tensiometric cantilever disposed therein, wherein the distal end of said cantilever comprises a cylindrical wire for interfacing with said biological sample; and (b) a micromanipulator for displacing said biological sample; measuring force on said cantilever; measuring vertical displacement of said sample; and collecting and analyzing data.

In another embodiment, the invention provides a method for measuring stiffness of a soft material with sub-millimeter resolution, the method comprising: providing a stiffness measuring device, said device comprising a force probe having a tensiometric cantilever disposed therein, wherein the distal end of said cantilever comprises a cylindrical wire for interfacing with said material; and a micromanipulator for displacing said material.

In another embodiment, the invention provides a method for measuring stiffness of a soft material with sub-millimeter resolution, the method comprising: providing a stiffness measuring device, said device comprising a force probe having a tensiometric cantilever disposed therein; and a micromanipulator for displacing said material; producing relative motion between said force probe and said material by indenting said material towards said force probe using said micromanipulator; detecting the relative motion; measuring a force on said force probe when said material interacts with said force probe; and analyzing the data, and thereby measuring stiffness of said material.

Other features and advantages of the present invention will become apparent from the following detailed description examples and figures. It should be understood, however, that the detailed description and the specific examples while indicating preferred embodiments of the invention are given by way of illustration only, since various changes and modifications within the spirit and scope of the invention will become apparent to those skilled in the art from this detailed description.

### BRIEF DESCRIPTION OF THE DRAWINGS

The invention will be better understood from a reading of the following detailed description taken in conjunction with the drawings in which like reference designators are used to designate like elements, and in which:

FIG. 1 shows a device for measuring tissue stiffness, according to one embodiment of the invention.

FIG. 2 shows a device for measuring tissue stiffness, according to one embodiment of the invention.

FIG. 3 shows a method for measuring tissue stiffness, according to one embodiment of the invention.

FIG. 4 shows S phase entry and cyclin D1 inhibition by tissue compliance, (a) Serum-starved MCF10A cells and primary VSMCs were seeded on ECM-coated acrylamide hydrogels (0.3-0.03% bis-acrylamide) and incubated with mitogens and BrdU. After 24 h (MCF10A, ▪) or 48 h (VSMC, ♦), cells were fixed and analyzed for BrdU incorporation. The results are plotted as fold inhibition of BrdU incorporation compared to the stiffest bio-gel (0.3% bis-acrylamide). The shaded area of the graph highlights the range of shear moduli measured in mouse mammary glands and arteries; 200-900 Pa. (b) MCF10A cells were plated on collagen-coated acrylamide hydrogels at 600 Pa (called physiological compliance; P) or at 8000 Pa which falls within the compliance range of breast tumors (called tumor compliance; T). A 600 Pa FN-coated hydrogel was used to model physiological arterial compliance (P), and an 8000 Pa FN-coated hydrogel was used to model the reduced compliance of stiffened arteries (RC). Serum-starved MCF10A cells and VSMCs were seeded on the hydrogels and stimulated with mitogens. After 12 h (MCF10A) or 24 h (VSMC), total RNA was collected. Cyclin D1 mRNA levels were measured by QPCR. The results were normalized to the low compliance sample, (c) Cells were starved, pretreated for 30 min with either DMSO (vehicle) or U0126 (50 joM), and seeded on the 8000 Pa hydrogels in the presence of mitogens. After 12 h (MCFIOA) or 24 h (VSMC), total RNA was collected and cyclin D1 mRNA levels were measured by QPCR. Data was normalized to the DMSO-treated sample, (d-f) Starved MCFIOA cells and VSMCs were seeded on the high and low compliance ECM-coated hydrogels as described for b. (d-e) Total RNA was collected 0-3 h after reseeding and analyzed for Fra-1 mRNA and JunB mRNA by QPCR. The levels of the transcripts are plotted relative to their low-compliance sample, (f) Protein was collected 3 h after reseeding and analyzed by western blotting. The vertical line in the MCFIOA blot indicates where extraneous information was removed from the gel.

### DETAILED DESCRIPTION OF THE INVENTION

The invention relates to a device for measuring tissue stiffness. Specifically, the invention relates to a device for measuring tissue stiffness with sub-millimeter resolution.

In one embodiment, provided herein is a device for measuring stiffness of a biological material with sub-millimeter resolution, the device comprising: a force probe having a tensiometric cantilever disposed therein, wherein the distal end of said tensiometric cantilever has a cylindrical wire for interfacing with said biological material; and a micromanipulator for displacing said biological material. In another embodiment, provided herein is a device for measuring stiffness of a soft material with sub-millimeter resolution, the device comprising: a force probe having a tensiometric cantilever disposed therein, wherein the distal end of said tensiometric cantilever has a cylindrical wire for interfacing with said biological material; and a micromanipulator for displacing said soft material. In another embodiment, provided herein is a milliprobe indentation device for measuring stiffness of a biological sample, the device comprising: a force probe comprising a tensiometric cantilever disposed therein, wherein the distal end of said cantilever comprises a cylindrical wire for interfacing with said biological sample; and a micromanipulator for displacing said biological sample, wherein said milliprobe indentation device is interfaced with an inverted microscope for simultaneous imaging and indentation.

In another embodiment, provided herein is a method for measuring stiffness of a soft material with sub-millimeter resolution, the method comprising: providing a stiffness measuring device, said device comprising a force probe having a tensiometric cantilever disposed therein, wherein the distal end of said tensiometric cantilever has a cylindrical wire for interfacing with said material; and a micromanipulator for displacing said material. In another embodiment, provided herein is a method for measuring stiffness of a soft material with sub-millimeter resolution, the method comprising: providing a stiffness measuring device, said device comprising a force probe having a tensiometric cantilever disposed therein; and a micromanipulator for displacing said material; producing relative motion between said force probe and said material by indenting said material towards said force probe using said micromanipulator; detecting the relative motion; measuring a force on said force probe when said material interacts with said force probe; and analyzing the data, and thereby measuring stiffness of said material.

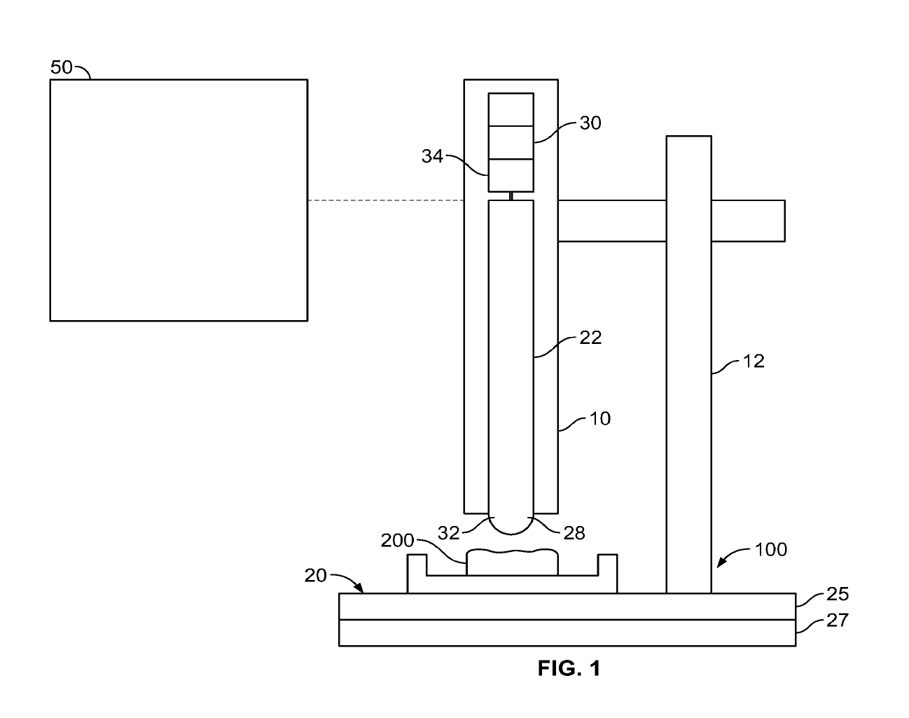

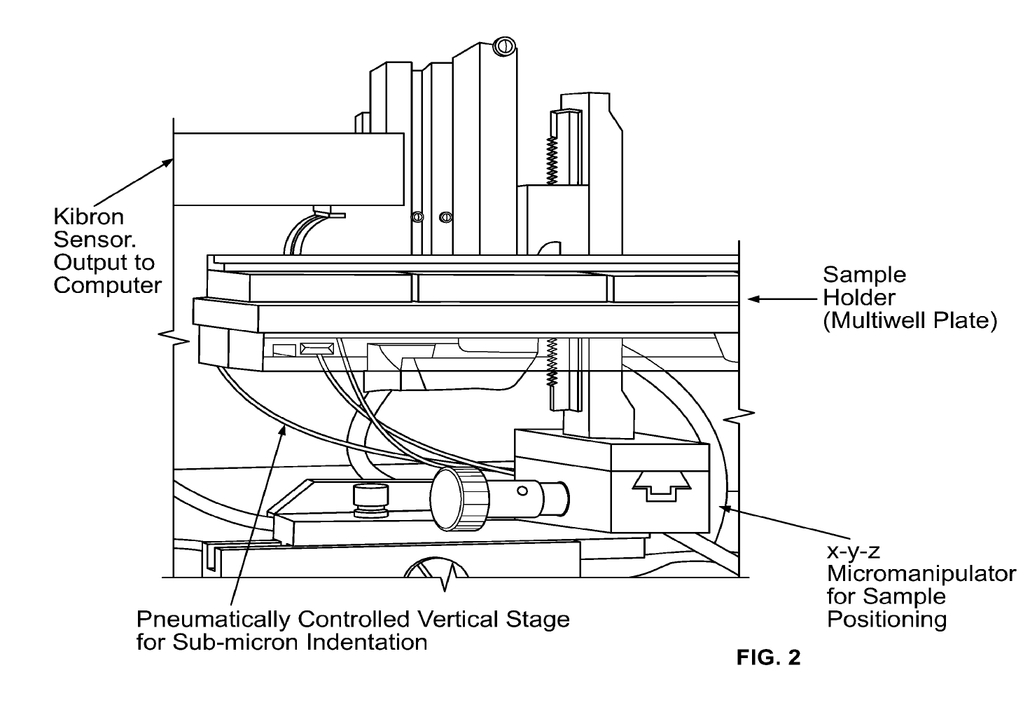

As shown in FIG. 1, device 100 comprises force probe 10, micromanipulator 20 and control unit 50. In one embodiment, force probe 10 is fixed to and held by stand 12, and control unit 50 controls driving of each unit of force probe 10 and manipulates a signal detected from each sensor of force probe 10. In an exemplary embodiment, device 100 is a milliprobe indentation device.

In some embodiments, force probe 10 is a microNewton-resolution forceprobe. In one embodiment, force probe 10 is taken directly from a surface tension measurement apparatus (e.g., commercially-available Langmuir monolayer trough developed by Kibron, Inc). Force probe 10 comprises measuring element 22 and motor 30. In one embodiment, motor 30 drives measuring element 22 upward and downward. Measuring element 22 comprises tensiometric cantilever 28. Displacement sensor unit 34 is integrally fixed to motor 30 and detects the travel of measuring element 22 based on the number of revolutions of the drive shaft of motor 30. Motor 30 is fixed to force probe 10 and drives measuring element 22 upward and downward, measuring element 22 being arranged to be vertically movable in force probe 10.

Tensiometric cantilever 28 is composed of integrally coupled wire 32 (e.g., titanium wire) that hangs from the distal end of tensiometric cantilever 28. The radius of titanium wire 32 can appropriately be set depending on the size and type of cultured tissue and on the method for measurement.

In one embodiment, the cross-sectional radius of titanium wire 32 ranges from about 100 μm to about 500 μm. In another embodiment, the cross-sectional radius of titanium wire 32 ranges from about 150 μm to about 300 μm. In another embodiment, the cross-sectional radius of titanium wire 32 ranges from about 200 μm to about 250 μm. In another embodiment, the cross-sectional radius of titanium wire 32 is about 225 μm.

Displacement sensor unit 34 includes a displacement sensor composed of, for example, an encoder and potentiometer. The displacement sensor detects the displacement in position based on the travel of measuring element 22 when it is driven by motor 30 arranged in probe 10 and moves upward and downward in FIG. 1.

Force probe 10 is movably arranged with respect to stand 12. Stand 12 includes stage 18 that faces wire 32 arranged at the lower end of probe 10. A material 200 (e.g., a cultured tissue) to be measured is placed on stage 18.

Micromanipulator 20 comprises a positioning element 25 and a base element 27. In one embodiment, positioning element 25 and base element 27 are mechanically connected so that positioning element 25 is movable relative to base element 27 in at least one direction. In some embodiments, micromanipulator 20 is a nanometer resolution micromanipulator known to one of skilled in the art.

Control unit 50 is connected to displacement sensor unit 34, respectively, and calculates displacement information from the displacement detected by displacement sensor unit 34. The displacement information is calculated based on positional information from displacement sensor unit 34. In the present embodiment, any position is defined as an initial position, and the initial position is defined as a reference position in the positional information. Then, the reference position is defined as zero and travel upon the downward movement of measuring element 22 driven by motor 30 is defined as positive, and the positional information obtained in this procedure is defined as the displacement information.

Alternatively, distance between the initial position of measuring element 22 and the position at which measuring element 22 is brought into contact with the cultured tissue is defined as an idle distance, and the travel of measuring element 22 after contact with the cultured tissue is defined as the displacement information.

In the computer connected to control unit 50, a user may set a variety of measuring conditions. Measuring condition items to be set include moving velocity and travel of measuring element 22. The computer controls the movement of measuring element 22 driven by motor 30, through control unit 50 based on these set conditions. Information detected by each sensor unit is transmitted to control unit 50, and is recorded in synchronism in a memory.

In one embodiment, device 100 measures the stiffness of material 200 at a resolution scale ranging from about 100 micron to about 1 millimeter. In another embodiment, device 100 measures the stiffness of material 200 at a resolution scale ranging from about 200 micron to about 800 micron. In another embodiment, device 100 measures the stiffness of material 200 at a resolution scale ranging from about 400 micron to about 600 micron. The elastic moduli of material 200 may range from about 100 Pa to about 5000 Pa.

Material 100 may refer to any soft material. In one embodiment, device 100 measures the stiffness of a whole tissue for example a biopsy tissue. In one embodiment, device 100 measures the stiffness of a soft tissue. Device 100 measures the stiffness of an in vitro cultured tissue. Such cultured tissues to be measured can be any tissues that are cultured in vitro and the stiffness thereof can be measured by device 100, as far as the stiffness or elasticity thereof changes with the passage of culture period. Such cells contained in such cultured tissues include, for example, chondrocytes, osteoblasts, fibroblasts, endothelial cells, epithelial cells, myoblasts, adipocytes, hepatic cells, nerve cells, and progenitor cells of these cells.

In one embodiment, device 100 measures the stiffness of a non-living soft material. Examples of non-living soft material include, but are not limited to, a polymer, a contact lens, and a silicone implant.

Device 100 can measure the stiffness both under hydrated (wet) environment and dry environment.

In another embodiment, the invention provides a method for measuring stiffness of a biological sample, the method comprising: providing a milliprobe indentation device 100 for measuring stiffness of a biological sample 200, the device comprising: (a) a force probe comprising a tensiometric cantilever 28 disposed therein, wherein the distal end of said cantilever 28 comprises a cylindrical wire 32 for interfacing with said biological sample 200; and (b) a micromanipulator 20 for displacing said biological sample 200; and measuring stiffness of said biological sample 200.

In another embodiment, the invention provides a method for measuring stiffness of a removed tissue or biopsy sample of a subject, the method comprising: providing a milliprobe indentation device 100 for measuring stiffness of a biological sample 200, the device 100 comprising: (a) a force probe 10 comprising a tensiometric cantilever 28 disposed therein, wherein the distal end of said cantilever 28 comprises a cylindrical wire 32 for interfacing with said biological sample 200; and (b) a micromanipulator 20 for displacing said biological sample 200; and measuring stiffness of said biological sample 200.

In another embodiment, the invention provides a method for measuring stiffness of a biological sample 200 with sub-millimeter size scale, the method comprising: collecting said biological sample 200 from a subject; providing a milliprobe indentation device 100 that comprises: (a) a force probe 10 comprising a tensiometric cantilever 28 disposed therein, wherein the distal end of said cantilever 28 comprises a cylindrical wire 32 for interfacing with said biological sample 200; and (b) a micromanipulator 20 for displacing said biological sample 200; measuring force on said cantilever 28; measuring vertical displacement of said sample 200; and collecting and analyzing data.

In another embodiment, the invention provides a method for measuring stiffness of a removed tissue or biopsy sample with sub-millimeter size scale, the method comprising: collecting said biological sample from a subject; providing a milliprobe indentation device 100 that comprises: (a) a force probe 10 comprising a tensiometric cantilever 28 disposed therein, wherein the distal end of said cantilever 28 comprises a cylindrical wire 32 for interfacing with said biological sample 200; and (b) a micromanipulator 20 for displacing said biological sample 200; measuring force on said cantilever 20; measuring vertical displacement of said sample 200; and collecting and analyzing data.

In another embodiment, the invention provides a method for measuring stiffness of a soft material with sub-millimeter resolution, the method comprising: providing a stiffness measuring device 100, said device comprising a force probe 10 having a tensiometric cantilever 28 disposed therein, wherein the distal end of said tensiometric cantilever 28 has a cylindrical wire 32 for interfacing with said material; and a micromanipulator 20 for displacing said material.

In another embodiment, the invention provides a method for measuring stiffness of a soft material with sub-millimeter resolution, the method comprising: providing a stiffness measuring device 100, said device comprising a force probe 10 having a tensiometric cantilever 28 disposed therein; and a micromanipulator 20 for displacing said material; producing relative motion between said force probe 10 and said material by indenting said material towards said force probe 10 using said micromanipulator 20; detecting the relative motion; measuring a force on said force probe 10 when said material interacts with said force probe 10; and analyzing the data, and thereby measuring stiffness of said material.

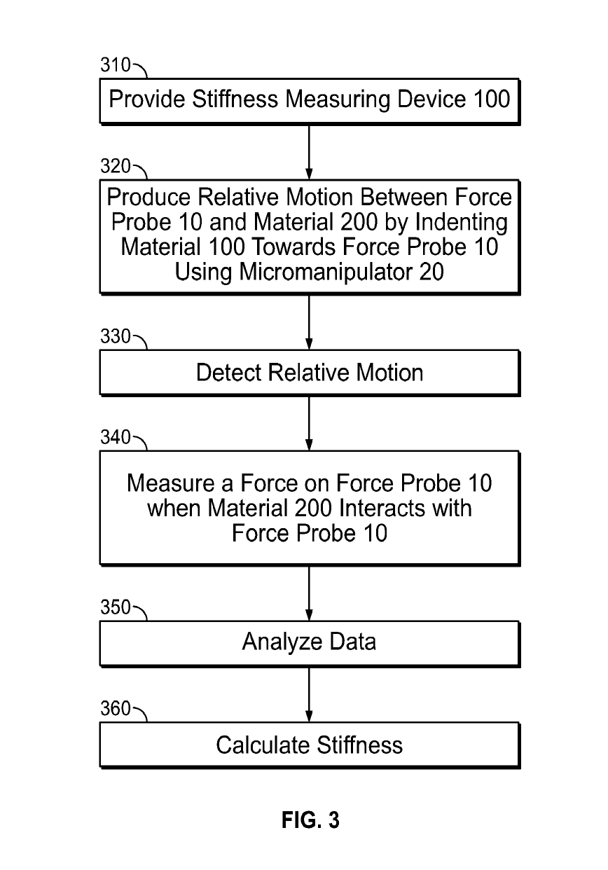

FIG. 3 shows a method for measuring tissue stiffness, according to one embodiment of the invention. As shown in item 320, relative motion between force probe 10 and material 200 is produced by indenting material 200 towards force probe 10 using micromanipulator 20. As shown in item 330, relative motion is detected. As shown in item 340, a force on force probe is measured when material 200 interacts with force probe 10. As shown in item 350, data is collected and analyzed. As shown in 360, stiffness is calculated. In some embodiments, the stiffness is calculated in accordance with the following formulae:

E=P(1−ν²)/2aωk

wherein E is the Young's module; P is the force on said cantilever; ν is the Poisson ratio; ω is the vertical displacement of said sample; and k is the sample thickness correction factor. In one embodiment, a processor connected to control unit 40 calculates the stiffness.

The following examples are presented in order to more fully illustrate the preferred embodiments of the invention. They should in no way be construed, however, as limiting the broad scope of the invention.

### EXAMPLES

### Example 1

### Device Measuring Tissue Stiffness

The inventors of the instant application have combined two existing technologies (a microNewton-resolution force probe and a nanometer-resolution micromanipulator) for measurement of the stiffness of biologically-relevant samples with high spatial and stiffness resolution. The force probe was taken directly from the surface tension measurement apparatus of a commercially-available Langmuir monolayer trough developed by Kibron, Inc, while the micromanipulator is an off-the-shelf product. The part of the probe that interfaces with the sample is a plane-ended cylindrical titanium wire with a cross-sectional radius of 255 μm that hangs from the end of a tensiometric cantilever. The method involves bringing the sample into contact with the free-hanging probe, followed by high resolution translation of the sample upward into the probe. The resulting force on, and upward displacement of, the probe are monitored with commercially available software and converted into a quantification of the sample stiffness using the method of Hayes et al which corrects for finite sample thickness. Calibration, setup, and experimentation with this method are simple, rapid, and direct.

The method and apparatus has been developed, calibrated, and extensively characterized. Quantification of well-characterized polyacrylamide gels with the method of the invention compares favorably with both macroscale (bulk rheology) and microscale (AFM) stiffness measurements, confirming the accuracy of this method. While most of the measurements were performed with stepwise indentations of 5-10 μm, continuous indentation is possible, and easily achievable with automation of the technique or manual control of the micromanipulator.

The device and method is applicable to a large variety of sample thickness, stiffnesses, geometries, and environments. The device was used to quantify the bulk stiffness of an isolated hydrated mouse glomerulus, the first such measurement, and one whose quantification may have implications for nephron pathology. The wall stiffness of explanted mouse aorta sections was also quantified and shown to be spatially heterogeneous in a manner possibly relevant to cardiovascular disease. Finally, the lateral stiffness variation was quantified in large tissue samples, specifically isolated mouse mammary glands and rat livers. These measurements of whole tissues differed from the previous measurement of microscopic samples in that they were performed without submersion of the sample, demonstrating the utility of the technique for both “wet” and “dry” sample preparations. The stiffness measured in the tissue samples agreed with both bulk rheology and compression, and also correlated strongly with histological observation of fibrosis and/or hyperproliferation.

In addition to quantification of stiffness, as defined by sample elastic moduli, other mechanical properties of the samples can also be evaluated. While translation of the sample into the probe produces an immediate indentation and resulting force, there is also a long time-scale relaxation observed in biological samples, which is not present in synthetic polymer hydrogels. This relaxation is indicative of viscoelastic material behavior and can be fit to appropriate models to derive material parameters such as creep time constants and loss moduli.

The applications described above validate the method described as a unique and effective way to quantify stiffness of soft biological samples, in addition to showing the utility of this method in correlating tissue stiffness with function and pathophysiology. The commercial application of the device and method described in this application is the development of a simple and inexpensive device capable of evaluating the stiffness of samples in the biologically-relevant range of elastic moduli (100-5000 Pa) with a sub-millimeter lateral resolution. The most direct commercial purpose of such a device would be for academic or industrial research into the lateral heterogeneity of macroscopic biological samples such as extracted tissues or biopsies. The lack of constraint in sample size, topology, or environment emphasizes the utility of this technique for a variety of distinct applications. Additional uses of the proposed device would be industrial characterization of the mechanical properties of soft materials (e.g. polymers used in contact lenses or silicone implants) at length scales inaccessible to current technologies.

The device addresses the disadvantages of the above technologies in that it can be assembled from relatively inexpensive, commercially available components and operated quickly and easily without much training. Data interpretation is relatively simple compared to other methods, with the only unknown factor being the thickness of the sample being probed, which can be easily measured by microscopy (this factor becomes unimportant to the calculation when samples are >1.25 mm thick). Technically, this technique is advantageous because it can probe a wide variety of sample sizes (50 urn-10 s of centimeters), types, and shapes in both hydrated and dry environments. It can measure both instantaneous and long-time material behavior, is readily amenable to automation, and could probe variable length scales by variation of the probe radius.

### Example 2

### Cell Cycle Inhibition by Physiological Matrix Compliance

### Materials and Methods:

Cell Culture.

Spontaneously immortalized MEFs (MEFs) and MCF10A mammary epithelial cells were maintained as previously described. Primary mouse VSMCs were isolated from 2-3 month old male C57BL/6 aortic explants, and used at passages 2-5. FAK-null MEFs were maintained in DMEM with 5% FBS. To synchronize cells in GO, MEFs and VSMCs were grown to ˜90% confluence and serum-starved for 48-72 h in DMEM with 1 mg/ml heat inactivated, fatty-acid free BSA. MCF10A cells were synchronized by growing to −90% confluence and starving for 48 h in 1:1 DMEM:Ham's F12 nutrient medium with 1 mg/ml BSA. The quiescent cells were trypsinized and suspended in serum-free media for 30 min at 37° C. prior to reseeding with mitogens. MEFS and VSMCs were stimulated with 10% FBS. MCF10A cells were stimulated with 10% FBS plus a growth factor cocktail containing 20 ng/ml epidermal growth factor (EGF; BD Biosciences), 10 ug/ml insulin (Sigma), 0.5 ug/ml hydrocortisone (Sigma), and 100 ng/ml cholera toxin (List Biologicals). In some experiments, trypsinized cells in DMEM, 1 mg/ml fatty acid-free BSA were pre-incubated in suspension (30 min at 37° C.) with 50 uM U0126 prior to reseeding. Adenoviruses were titered and used as described.

Preparation of ECM-Coated Hydrogels. Polyacrylamide gels were covalently attached to 25-mm glass coverslips (Fisher) as described previously. The acrylamide concentration remained constant at 7.5%, and the bis-acrylamide concentration was 0.3% for the low compliance gels and 0.03% for the high compliance gels. The shear moduli under these conditions were 8000 Pa and 600 Pa, respectively, as measured by rheology. Gels were placed in 6-well plates and coated overnight with either 2 ml collagen solution (6.12 ug/ml in PBS; for MCF10A cells) or FN solution (3.05 μg/ml in PBS; for MEFs and VSMCs).

Measurement of Mouse Tissue Compliance by Milliprobe Indentation.

The stiffness of isolated transected aortae and mammary fat pads were measured using a custom-built milliprobe indentation device. The device consists of a μN resolution force probe and a 100 nm resolution micromanipulator (MLW-3, Narishige, Tokyo, Japan). The force probe is adapted from the surface tension measurement apparatus of a Langmuir trough (MicroTroughX, Kibron Inc., Helsinki, Finland) which consists of a tungsten wire (blunt-ended cylinder; radius=275 μm) hung from a tensiometric cantilever. The probe acts as a Hookean cantilever whose deflection is directly proportional to its vertical displacement (calibrated with known weights and displacements). Briefly, the tissues were brought into contact with the probe by coarse adjustment of the stage followed by 7 successive 5-10 μm upward displacements of the sample towards the probe. These displacements lead to upward deflections of the cantilever as well as small indentations into the sample. The magnitude of indentation and force on the sample were calculated from cantilever calibrations, and averaged to derive the average indentation and force on the sample. These were used to quantify sample stiffness by the method of Hayes et al., which calculates stiffness corrected for sample thicknesses on the scale of the radius of the indenter.

E=P(1−ν²)/2aωk

where E is the Young's modulus, P is the force on the cantilever, ν is the Poisson ratio, ω is the vertical displacement of the sample, and K is the sample thickness correction factor. The Young's modulus was converted to shear modulus (G) using the equation

$$G = \frac{E}{2 ( 1 + v )}$$

Aorta sample thicknesses were determined microscopically on hematoxylin and eosin-stained paraffin sections of mouse aorta using Image Pro Software. The thickness of the mammary tissue was measured with a caliper. Poisson's ratios of 0.45 and 0.5 were assumed for aortae and mammary fat pads, respectively. Multiple measurements were made on each tissue sample and outliers were discarded according to Chauvenet's criterion. Measurements of polyacrylamide gels made using this method were consistent with previous bulk stiffness measurements done by rheology.

### Cell Cycle Inhibition by Physiological Matrix Compliance.

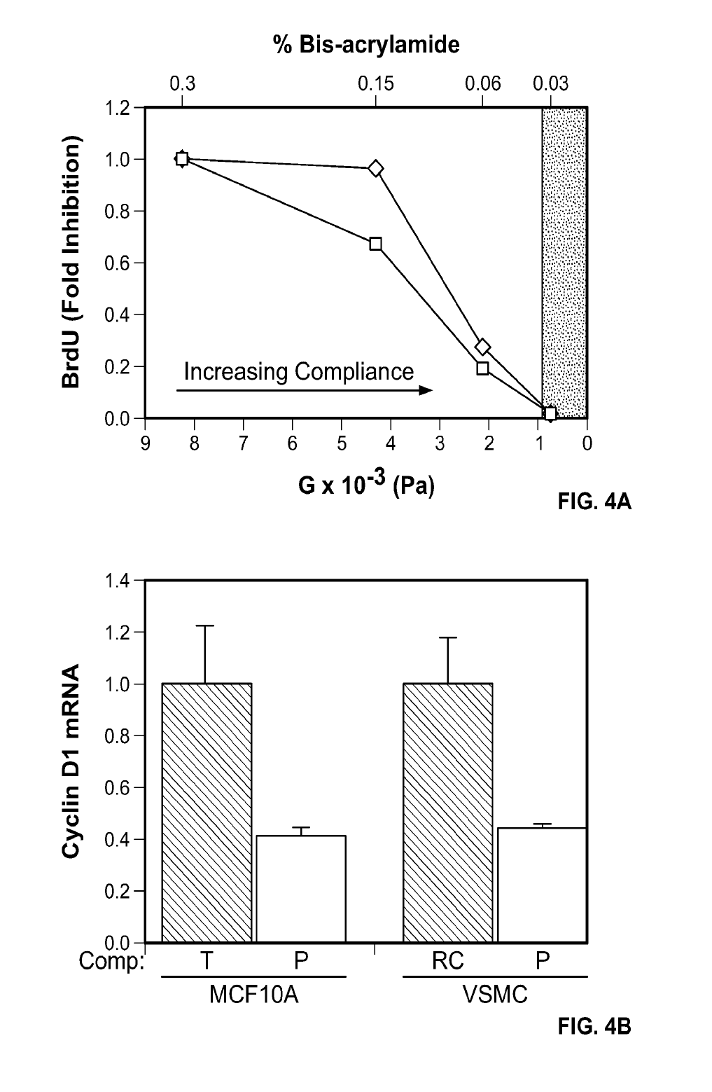

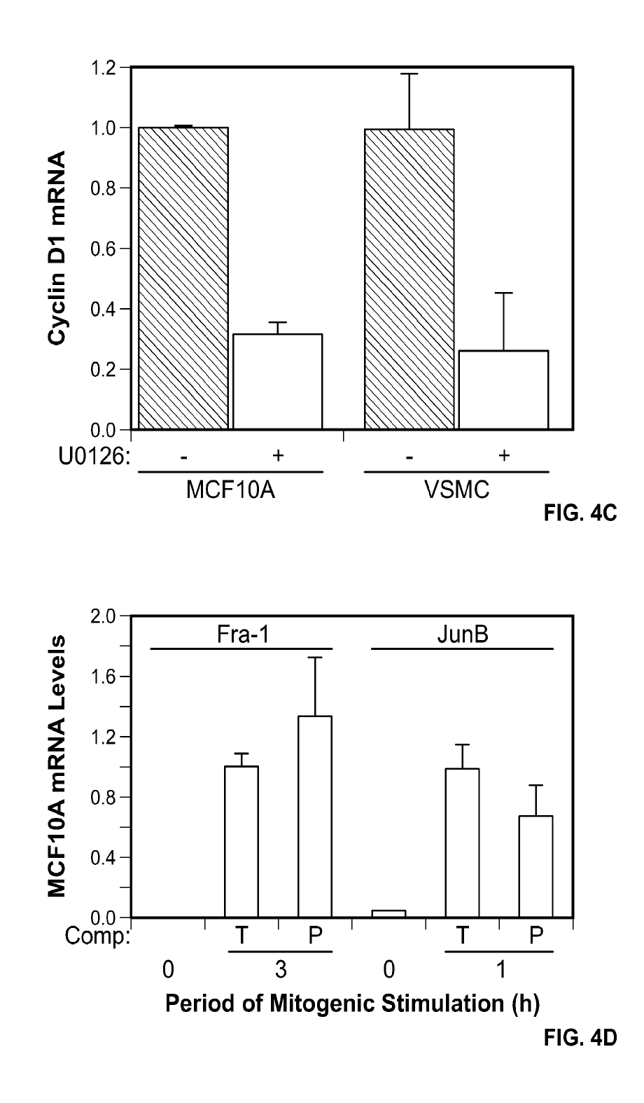

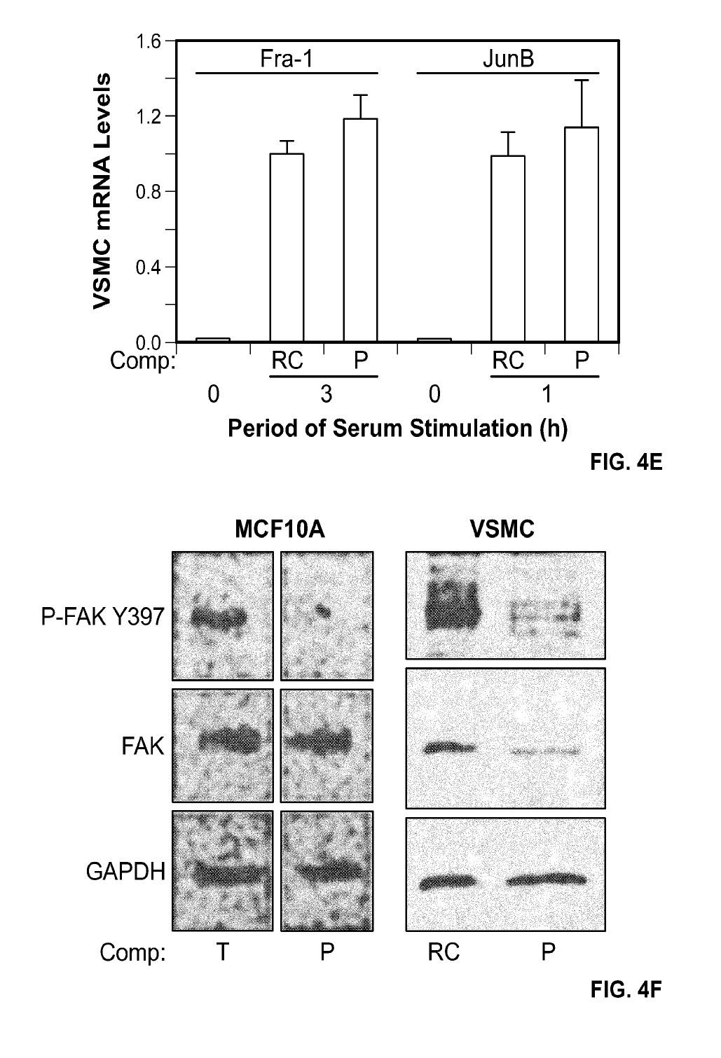

The inventors of the instant application have adapted the use of deformable matrix protein-coated acrylamide hydrogels to a molecular analysis of the cell cycle. Quiescent mouse embryo fibroblasts (MEFs) were plated on fibronectin (FN)-coated hydrogels having compliances within the physiological range (shear moduli, G ˜600-8000 Pa) with the endpoints referred to as high and low compliance, respectively. As seen on non-deformable substrata, serum stimulated S phase entry when MEFs were plated on the low compliance FN substratum, and these cells used ERJK. activity to induce cyclin D1 mRNA and protein as determined with the MEK inhibitor, U0126. Consistently, S phase entry was inversely related to ECM compliance, and the high compliance substratum inhibited both S phase entry and cyclin D1 induction. To test the importance of ECM compliance on cell physiology, the compliance of freshly isolated 3-month old C57BL/6 mouse inguinal mammary glands was measured by milliprobe indentation and obtained a shear elastic modulus of −200 Pa, similar to that measured for human breast adipose tissue (G-300-1000 Pa). Mitogen-stimulated MCF10A human mammary epithelial cells were then cultured on collagen-coated acrylamide substrata within this range (G-600 Pa; called physiological compliance; P; shaded area of FIG. 4a) and at 4000-8000 Pa to approximate the range of shear moduli in breast tumors (called tumor compliance; T; unshaded area of FIG. 4a). At tumor compliance, mitogen stimulated MCF10A cells entered S phase (FIG. 4a) and expressed cyclin D1 in an ERK-dependent manner (FIGS. 4b and c). Physiological compliance inhibited S phase entry and cyclin D1 gene expression (FIGS. 4a and b), but ERK activation and function, as assessed by induction of Fra-1 and JunB (FIG. 4d), were minimally affected by changes in ECM compliance. Thus, the physiological compliance of the mammary gland prevents cyclin D1 expression and S phase entry, and breast tumors can circumvent this control by tissue stiffening.

To examine the potential importance of tissue compliance in cardiovascular biology, arteries from 4-8 month old C57BL/6 mice were isolated and the compliance of the thoracic aorta, abdominal aorta, and femoral artery were measured using either milliprobe indentation or atomic force microscopy. These tissues had a narrow shear modulus range of 200-900 Pa (shaded area of FIG. 4a). Primary vascular smooth muscle cells (VSMCs) isolated from the mouse aorta were then cultured on a compliance-appropriate FN substratum (G=600 Pa; called physiological compliance; P) as well as hydrogels of −2000-8000 Pa (called reduced compliance; RC). At physiological compliance, VSMCs did not enter S phase (FIG. 4a; shaded area), while efficient cell cycle progression was observed on FN-coated hydrogels at reduced compliance (FIG. 4a; G>4000 Pa). Again, physiological tissue compliance was associated with an inhibition of ERK-dependent cyclin D1 gene expression (FIGS. 4b and c) despite normal ERK function (FIG. 4e). Reduced compliance rescued cyclin D1 gene induction (FIG. 4b). The relationship between tissue compliance and VSMC proliferation in vivo may be complicated by pulsatile blood flow, the plasticity of VSMC differentiation, and the effects of anti-proliferative signals derived from adjacent intimal endothelial cells. Nevertheless, the association between VSMC proliferation and ECM/arterial stiffening in cardiovascular disease strongly suggests that the compliance of the microenvironment is likely to be an important regulator of VSMC cycle in vivo.

Strikingly, the shear moduli that inhibit S phase entry in MEFs, mammary epithelial cells (FIG. 4a), and VSMCs (FIG. 4a) are similar. Moreover, all three cell types require cyclin D1 for mitogenesis and show an inhibition of FAK autophosphorylation and cyclin D1 gene expression (FIG. 4b) when cultured on a substratum of physiologically relevant compliance. Thus, the effect of tissue compliance on the cell cycle appears to be broadly applicable, at least in cyclin D1-dependent cells. Some cells may be resistant to this control due to the cyclin D isoforms they express, their particular tensional requirements, or their tissue microenvironments. These parameters, as well as cell type-specific compensation by Pyk2, may explain the variable effects of FAK knock-out on cell proliferation.

It is noted that the use of acrylamide hydrogels with shear moduli of 600-8000 Pa was based on the ability of the compliances to regulate mitogenesis and model the stiffnesses of the mammary gland and major arteries.

Tissue compliance is thought to change during matrix remodeling, an event frequently associated with both cancer and cardiovascular diseases such as atherosclerosis and restenosis. Control of the cell cycle by tissue compliance as described here can contribute to the absence of proliferation in normal tissues as well as the increased proliferation of cells seen during pathological ECM remodeling and stiffening of the microenvironment.

Having described preferred embodiments of the invention with reference to the accompanying drawings, it is to be understood that the invention is not limited to the precise embodiments, and that various changes and modifications may be effected therein by those skilled in the art without departing from the scope or spirit of the invention as defined in the appended claims.

1. A milliprobe indentation device for measuring stiffness of a biological sample, the device comprising:
a. a force probe comprising a tensiometric cantilever disposed therein, wherein the distal end of said cantilever comprises a cylindrical wire for interfacing with said biological sample; and
b. a micromanipulator for displacing said biological sample.

2. The device of claim 1, wherein said force probe is a microNewton-resolution force probe.

3. The device of claim 1, wherein said wire is a plane-ended cylindrical titanium wire.

4. The device of claim 1, wherein said micromanipulator is a nanometer-resolution micromanipulator.

5. The device of claim 1, wherein said probe acts as a Hookean cantilever whose deflection is directly proportional to its vertical displacement.

6. The device of claim 1, further comprises a processor that quantifies stiffness of said sample in accordance with the following formulae:
E=P(1−ν²)/2aωk
wherein E is the Young's module; P is the force on said cantilever; ν is the Poisson ratio; ω is the vertical displacement of said sample; and k is the sample thickness correction factor.

7. The device of claim 1, wherein said device is capable of measuring said sample at sub-millimeter size scale.

8. The device of claim 1, wherein the device measures stiffness of said sample at a resolution scale ranging from about 100 micron to about 1 millimeter.

9. The device of claim 1, wherein said sample is a whole tissue.

10. The device of claim 1, wherein said sample is a soft tissue.

11. The device of claim 1, wherein said sample is a removed tissue or biopsy sample.

12. The device of claim 1, wherein said sample is a polymer.

13. The device of claim 1, wherein the device is capable of measuring said sample under a hydrated environment.

14. The device of claim 1, wherein the device is capable of measuring said sample under a dry environment.

15. The device of claim 1, wherein the elastic moduli of said sample range from about 100 Pa to about 5000 Pa.

16. A device for measuring stiffness of a soft material with sub-millimeter resolution, the device comprising: (a) a force probe having a tensiometric cantilever disposed therein, wherein the distal end of said cantilever comprises a cylindrical wire for interfacing with said material; and a micromanipulator for displacing said material.

17.-31. (canceled)

32. A method for measuring stiffness of a biological sample, the method comprising:
providing a milliprobe indentation device according to claim 1;
measuring stiffness of said biological sample.

33. The method of claim 32, wherein said device is capable of measuring said sample at sub-millimeter size scale.

34. The method of claim 32, wherein said force probe is a microNewton-resolution force probe.

35. The method of claim 32, wherein said wire is a plane-ended cylindrical titanium wire.

36. The method of claim 32, wherein said micromanipulator is a nanometer-resolution micromanipulator

37. The method of claim 32, wherein said probe acts as a Hookean cantilever whose deflection is directly proportional to its vertical displacement.

38. The method of claim 32, wherein said sample is a removed tissue or biopsy ample.

39. The method of claim 32, further comprises a processor that quantifies stiffness of said sample in accordance with the following formulae:
E=P(1−ν²)/2aωk
wherein E is the Young's module; P is the force on said cantilever; ν is the Poisson ratio; ω is the vertical displacement of said sample; and k is the sample thickness correction factor.

40. (canceled)

41. A method for measuring stiffness of a biological sample with sub-millimeter size scale, the method comprising:
collecting said biological sample from a subject;
providing a milliprobe indentation device according to claim 1;
measuring force on said cantilever;
measuring vertical displacement of said sample; and
collecting and analyzing data.

42.-49. (canceled)

50. A method for measuring stiffness of a soft material with sub-millimeter resolution, the method comprising: providing a stiffness measuring device, said device comprising a force probe having a tensiometric cantilever disposed therein, wherein the distal end of said tensiometric cantilever has a cylindrical wire for interfacing with said material; and a micromanipulator for displacing said material.

51. A method for measuring stiffness of a soft material with sub-millimeter resolution, the method comprising:
providing a stiffness measuring device, said device comprising a force probe having a tensiometric cantilever disposed therein; and a micromanipulator for displacing said material;
producing relative motion between said force probe and said material by indenting said material towards said force probe using said micromanipulator;
detecting the relative motion;
measuring a force on said force probe when said material interacts with said force probe; and
analyzing the data, and thereby measuring stiffness of said material.

52. A milliprobe indentation device for measuring stiffness of a biological sample, the device comprising:
a. a force probe comprising a tensiometric cantilever disposed therein, wherein the distal end of said cantilever comprises a cylindrical wire for interfacing with said biological sample; and
b. a micromanipulator for displacing said biological sample,
wherein said milliprobe indentation device is interfaced with an inverted microscope for simultaneous imaging and indentation.
